(19) United States
(12) Patent Application Publication
(10) Pub. No.: US 2011/0078095 A1
(43) Pub. Date: Mar. 31, 2011

(54) PLASTIC LETTER TRAY ASSEMBLY KIT

(76) Inventor: Reiner Eckhardt, Dortmund (DE)

(21) Appl. No.: 12/793,807

(22) Filed: Jun. 4, 2010

(30) Foreign Application Priority Data
Sep. 29, 2009 (NL) 1037331

(51) Int. Cl. B65D 1/34; B65D 71/00; B29C 45/14; G06Q 90/00

(52) U.S. Cl. 705/500; 206/223; 206/557

(57) ABSTRACT

The invention relates to a kit for assembly of a plastic letter tray with an open front side and an open topside. The kit comprises a left side panel, a right side panel, a back panel, and a floor panel, which panels are provided with receiving apertures and/or insert lips, preferably snap fingers, for interconnecting the panels to assemble the letter tray. The panels are formed as one body in an injection mould, and are only disconnected from each other by the end user when assembling the letter tray. Thus there is nor risk of the panels getting lost or mixed up with panels of other letter trays during transport.

The panels are connected via breakaway connections. Furthermore, the left side panel is positioned with a bottom edge along the left side of the floor panel, the right side panel is positioned with a bottom edge along the right side of the floor panel, and the back panel is positioned with a bottom edge along the backside of the floor panel. Thus, the side panels and the back panel are positioned relative to the floor panel at the locations in which they should be connected to the floor panel for assembly of the letter tray. This facilitates assembly by the end user, who does not need to figure out which panel goes where.

### FIELD AND BACKGROUND OF THE INVENTION

The invention relates to plastic letter trays for use as desk top accessories and, more in particular, to a plastic letter tray assembly kit according to the preamble of claim 1.

Plastic desktop letter trays are conventional office accessories. The trays typically have a floor panel, two side panels, a back panel. The letter tray has an open top and an open forward end for receipt of paper. Typically, the floor panel is at its font end provided with a recess which facilitates engaging a letter supported in the letter tray by hand. Also, most letter trays are designed to be stacked upon each other to form a set of tiered storage trays.

The conventional trays have been well accepted and are a commercial success. However, one deficiency is that the letter trays, being integrally formed, are substantially bulky and, hence, expensive to ship. The cost of the packaging such products is a substantial component of the overall costs.

To save in the cost of transportation, it is for example known from U.S. Pat. No. 5,624,037 to design the tray as a kit. The kit comprises a floor panel including a back panel, and two separate side panels. For shipment, the side panels are stacked flat upon the floor panel such that a compact form is created. The stacked components can then be packaged in a relatively small container and shipped in a cost effective manner.

Although this solution allows for a relative compact form of the kit in disassembled state, it also requires the end user to assemble the tray from its components. Typically the panels for composing the letter tray look alike. It may therefore take considerable effort from the end user, in particular when it is an unskilled consumer, to assemble the final tray.

Also there is the risk of the separate panels getting lost or getting mixed up with panels of other letter trays during shipping and/or when unpacking multiple kits at the same time. This would further increase the effort required for combining the floor panel with the correct side panels to assemble the letter tray.

### OBJECT OF THE INVENTION

It is an object of the invention to provide an improved kit for composing a letter tray, in which the above mentioned drawbacks are eliminated altogether or occur in a greatly reduced extent.

In particular it is an object of the invention to provide a letter tray that can be shipped as a compact kit, in particular without the risk of separate panels getting lost or mixed up with panels of other kits.

Another objective is to provide a plastic letter tray kit that is economical to produce and simple to assemble.

Yet another objective is to provide a method for producing and selling a kit for assembly of a plastic letter tray with reduced risk of panels getting lost or mixed up during shipping.

### SUMMARY OF THE INVENTION

To achieve these objects, the invention provides a kit according to claim 1 and a method according to claim 11.

The invention relates to a plastic letter tray assembly kit for assembly of a letter tray with an open front side and open topside. The kit comprises a left side panel, a right side panel, a back panel, and a floor panel. These components are provided with receiving apertures and/or insert lips, preferably snap fingers, for interconnecting the panels for assembly of the letter tray.

The panels are formed as one body in an injection mould, wherein the panels are connected via breakaway connections. The left side panel is positioned with a bottom edge along the left side of the floor panel, the right side panel is positioned with a bottom edge along the right side of the floor panel, and the back panel is positioned with a bottom edge along the backside of the floor panel. Thus, the side panels and the back panel are positioned relative to the floor panel at the locations in which they should be connected to the floor panel for assembly of the letter tray. This facilitates assembly by the end user, who does not need to figure out which panel goes where.

Preferably the components are furthermore positioned relative to each other such that the insert lips and/or receiving apertures of the side panels and the back panel are positioned in the vicinity of the respective receiving apertures and/or insert lips of the floor panel with which they form a snap connection in the assembled letter tray. This further facilitates assembly by the end user, who does not need to figure out which insert goes into which receiving aperture.

Since the panels for assembling the plastic letter tray are connected to each other, there is no risk of panels getting lost or getting mixed up with panels of other kits during transport or assembly. There is no need for providing each kit with packaging for keeping the panels together. Multiple kits can be transported in one package, and can be sold without a package at all.

Also, since the side panels are fixed relative to each other they can not move over and along each other during transport, and thus not scratch or otherwise damage each other.

In general, the panels are positioned such that they form a blank of the assembled letter tray which allows for easy assembly of the letter tray by the end user. It is clear from the position of the panels in the kit how they should be fit together to assemble the final letter tray.

This is especially the case when the insert lips and/or receiving apertures of the side panel and the back panel are positioned in the vicinity of the respective receiving apertures and/or insert lips of the floor panel with which they form a snap connection in the assembled letter tray.

In a preferred embodiment, the side panels in the kit are connected to the back panel via a breakaway connection to enhance the stability of the kit. By providing extra connections between the side panels and the back panel, extra force is needed to disconnect the panels. Thus it is prevented that the side panels and/or the back panel break lose easily during, for example, transport.

In a further preferred embodiment, a back edge of the side panel and a side edge of the back panel are connected to each other via a corner component which is connected via breakaway connections to both the side panel and the back panel. The corner component allows for connecting a side panel and a back panel when they do not overlap with each other.

Furthermore, the sections of the side and back panel provided with these breakaway connections are positioned at the back of the assembled letter tray. Thus, the marks left on these components by the breakaway connections are not in plane view for the end user.

The corner component is formed as one monolithic body with the panels during production, and provides extra rigidity to the overall kit.

The corner component preferably comprises one or more plastic paperclips. Thus, the corner component is then not just a structural component of the kit. After use for providing stability to the non-assembled kit, it can be used as a paperclip. Thus a minimum of material is wasted and the end user is provided with an extra incentive to buy the kit.

In a further preferred embodiment, the side panels are each provided with a partially curved back part, and the back panel is provided with partially curved end parts, which curved end parts cooperate with the curved back parts to form a curved corners in the assembled letter tray. These partially curved sections interlock as puzzle pieces and thus function as visual indicators to the user, which indicate the user how the panels should be fit together.

In a further preferred embodiment, the floor panel is at its bottom side provided with a figure formed by injection moulding which indicate how to use the kit to assemble the plastic letter tray. Thus, no extra leaflet is necessary to provide the end user with instructions on how to assemble the letter tray. In a preferred embodiment the kit is sold without extra components, packaging or instruction leaflets, thus minimizing cost of packaging and transport.

In addition, multiple kits according to the invention can be packaged in a single retail package for transport from a production location to a vending location. The retail package comprising multiple, stacked kits according to the invention, wherein the panels of each kit are connected with each other via breakaway connections. Since each kit is a single product, there is no risk of panels getting lost or of panels of one kit getting mixed up with panels of another kit. Therefore there is no need of providing separate packaging for each kit.

Further objects, embodiments and elaborations of the both aspects of the invention will be apparent from the appended claims and from the following description, in which the invention is further illustrated and elucidated on the basis of a number of exemplary embodiments, with reference to the drawings.

### DESCRIPTION OF THE DRAWINGS

FIG. 1 shows a perspective view of a kit for assembling a plastic letter tray according to the invention;

FIG. 2 shows a bottom view of the kit from FIG. 1;

FIG. 3 shows a enlarged view of a corner of the kit from FIG. 1; and

FIG. 4 shows a letter tray assembled from the kit from FIG. 1.

### DETAILED DESCRIPTION

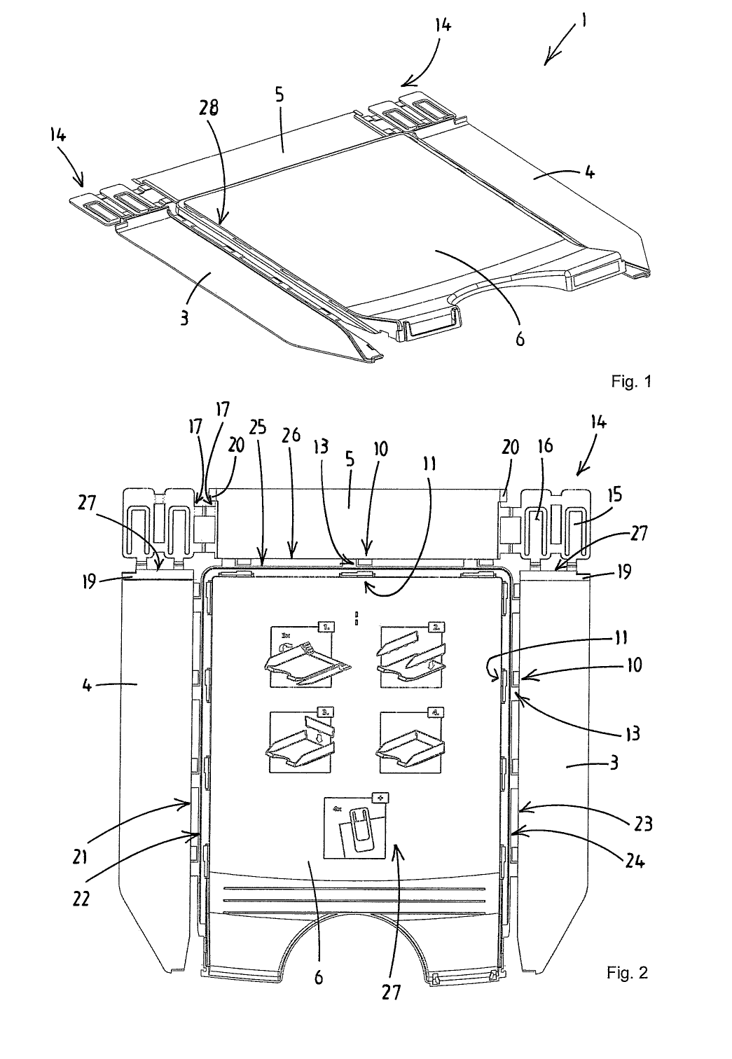

FIG. 1 shows a perspective view of a kit 1 for assembling a plastic letter tray according to the invention. A letter tray 2 assembled from such a kit is shown in FIG. 4. The plastic letter tray 2 comprises an open front side and an open topside, and a left side panel 3, a right side panel 4, a back panel 5, and a floor panel 6.

In the preferred embodiment shown, the floor panel comprises a front area 7 and a back area 8. The back area 8 extends in a substantially horizontal direction when the letter tray 2 is assembled and supported by a horizontal surface. The front area 7 extends at an angle with the back area. Due to the angled front area of the floor panel, a document place in the letter tray slides towards the back of the letter tray.

In an alternative embodiment, the size of front area and/or the angle with the back area may differ from the one shown. Furthermore, a floor panel may be provided which has a flat top surface and no angled front area.

Furthermore, in the preferred embodiment shown, the floor 6 is at its front provided with a recess 9. A document placed in the letter tray overlaps with the recess. Thus, both sides of the document can be engaged by hand. This allows for easy placing and easy removing of the document into and out of the letter tray.

In the particular embodiment shown, the recess has a semi circular shape. It is clear to the skilled person that other shapes are possible.

The letter tray 2 shown in FIG. 4 is assembled using the kit 1 shown in FIG. 1. The kit comprises a left side panel 3, a right side panel 4, a back panel 5, and a floor panel 6.

These panels are provided with receiving apertures and/or insert lips, preferably snap fingers, for interconnecting the panels to assemble the letter tray. In the particular embodiment shown, the side panels and back panel are provided with insert lips, more particular snap fingers 10 along their bottom edges for connecting them to the floor panel. The floor panel 6 is provided with apertures 11 for receiving these insert lips 10

The panels are formed as one body in an injection mould, wherein the panels are connected to each other via breakaway connections 13. Breakaway connections are connections connecting a first with a second part, which connection can be removed by folding the first and second part relative to each other. Breakaway connections differ from for example film hinges in that they are relatively brittle, such that they easily snap when loaded by folding.

Thus the kit according to the invention is one body, comprising multiple panels which can be separated from each other by folding the panels relative to each other. The panels are subsequently reconnected in the proper positions to form a letter tray using the snap fingers and the receiving apertures

The panels are positioned in the kit in a way to facilitate assembly of the letter tray by the end user. With a kit according to the invention, the left side panel 3, is positioned with a bottom edge 23 along the left side 24 of the floor panel 6, the right side panel 4 is positioned with a bottom edge 21 along the right side 33 of the floor panel 6, and the back panel 5 is positioned with a bottom edge 26 along the backside 25 of the floor panel 6.

Thus, the side panels and the back panel are already positioned in the location in which they need to be connected to the floor panel. The configuration of the panels therefore indicates the end user where they disconnected panels should be reconnected to the floor panel using the receiving apertures 11 and the insert lips 10.

Furthermore, in the preferred embodiment shown the panels form a blank of the assembled letter tray. The side panels and the back panels are positioned with their inside facing the same direction as the topside of the floor panel. Folding the panels along their bottom edge inward and upward relative to the floor panel positions them correctly for assembly of the letter tray. This configuration allows for simple assembly of the letter case by the end user.

In the preferred embodiment shown, the insert lips of the side panels and the back panel are positioned in the vicinity of the receiving apertures of the floor panel with which they form a snap connection in the assembled letter tray. This further allows for quick and easy assembly of the letter tray.

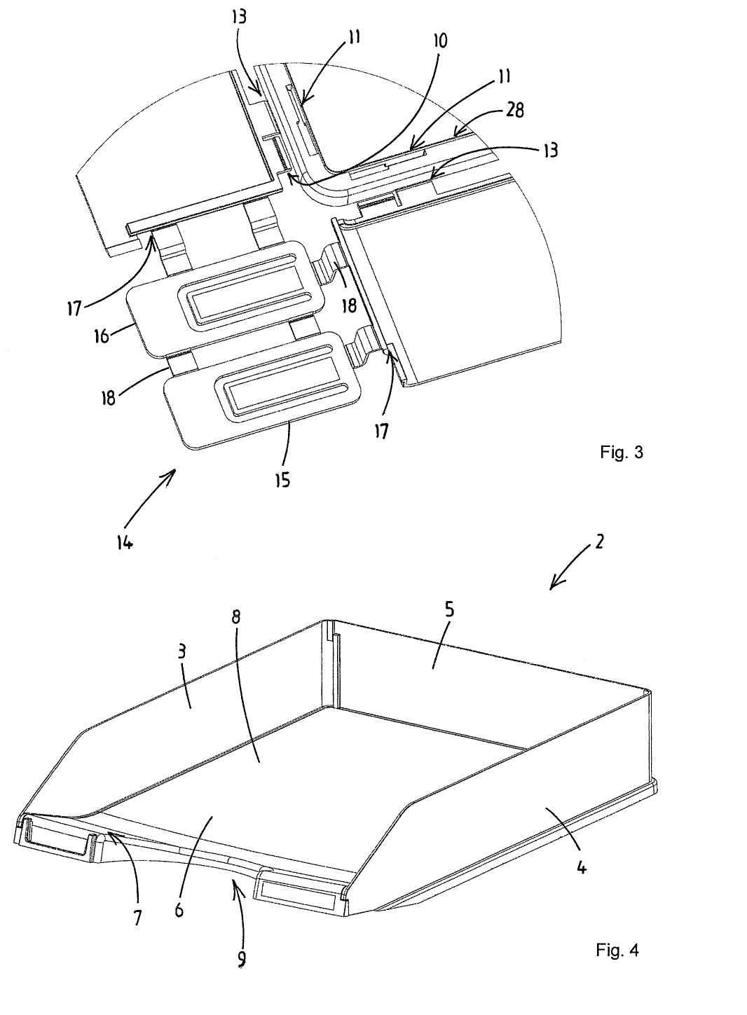

Preferably, the side panels in the kit are connected to the back panel via a breakaway connection for stability of the kit. In the preferred embodiment shown, a back edge of the side panel and a side edge of the back panel are connected to each other via a corner component 14, shown in more detail in FIG. 3. This corner component 14 is connected via breakaway connections 17 to both the left side panel 3 and the back panel 5. The corner component is formed as one part with the panels by injection moulding during the production process of the kit.

In the preferred embodiment shown, the corner components 14 each comprise two plastic paperclips 15, 16 each. Thus, the corner component 14 is essentially formed by the two paper clips 15, 16 and the elements connecting the paperclips together, in this particular case two bridges 18 provided with breakaway connections at both ends.

The breakaway connection connecting the paperclips to the panels is also formed by bridges 18 provided with breakaway connections at both ends.

Since the paperclips can be used after assembly of the letter tray, the bridges 18 are the only material which is disregarded after the letter tray is put together. Thus, the main part of the corner component is useful after assembly of the letter tray, and the waste of material is kept to a minimum.

In an alternative embodiment, the corner component for example comprises one paper clip or is for example shaped as a rectangular or triangular component which is disregarded after the components are disconnected and the

In an alternative embodiment, the kit can also be provided with the side panels translated along their bottom edge, relative to their position shown in for example FIG. 1, such that they overlap with the back wall. With such a lay out, the bottom edges of the side panels are located along the side edges of the back panel. Thus, the side panels can be connected via break away connections directly to the back panel, either in addition to or without the use of a corner component.

In a the preferred embodiment shown, the side panels 3,4 are each provided with a curved back part 19, and the back panel 5 is provided with curved end parts 20, which curved end parts 20 cooperate with the curved back parts 19 of the side panels 3, 4 to form curved corners in the assembled letter tray. The curved end parts further facilitate assembly of the letter tray since the left and right side panel now fit together with the back panel in one way only. Thus, they provide a visual indication on how the panels should be fit together.

Furthermore, in the preferred embodiment shown, the back ends of the side panels and the sides of the back panel are shaped such that when the letter tray is assembled the side panels and the back panel do not meet in the corner of the letter tray along a straight line. The back ends of the side panels interlock with the sides of the back panel and thus meet along a staggered line. This configuration allows for a more reliable connection, and also functions as an indicator on how the panels should be fit together.

In an alternative embodiment, the side panels and the back panel are configured such that they do not meet. Such a letter tray is open at its corners.

In the preferred embodiment shown, the floor panel 6 is provided with a receiving groove 28 for receiving a bottom edge of the left and right side panels and the bottom edge of the back panel. The receiving groove extends along the sides and back edges of the floor panel. In the groove, receiving slots 11 are provided for receiving the insert lips 10, preferably shaped like snap fingers, of the side panels and the back panel, such that the side panels and the back panel are inserted from above into the floor panel when assembling the letter tray. The groove helps the user to position the insert lips of the side panels and the back panel relative to the receiving apertures when assembling the letter tray.

FIG. 2 shows the bottom view of the kit shown in FIG. 1. In the preferred embodiment shown the kit according to the invention is provided with a FIG. 27 in relief, formed by injection moulding during the production process of the kit. The figure indicates how to use the kit to assemble the plastic letter tray. Thus there is no need for an extra leaflet with in instructions on how to assemble the letter tray, which save material and packaging costs.

The figure is an image relief on the bottom surface of the floor panel. Thus the figure is not in view when the assembled letter tray is used. In an alternative embodiment the figure can be applied to other panels or for example on a corner component.

The letter tray shown, in particular the floor panel, is dimensioned such that the assembled letter tray is capable of supporting letters of A4 format. Alternative dimensioned letter trays for supporting up to A3 or up to A5 dimensioned documents are also possible by changing the dimensions of the kit, more in particular of the panels for assembling the letter tray.

The invention furthermore provides a method for producing and selling a kit for assembly of a plastic letter tray according to the invention. The method comprises a production phase, a transport phase, and a vending phase.

The production phase comprises step of injection moulding the kit in one mould, the kit comprising the panels for assembly of the plastic letter tray. The kit is formed as one monolithic body, in which the panels are connected to each other, in one cavity in the injection mould.

Preferably the injection mould is designed such that each cavity for forming a panel is provided with an inlet for directly injecting fluid resin during production.

The panels are connected to each other via breakaway connections. Breakaway connections are known in the art and are formed by local constrictions in a body of material. Such constrictions form weak spots at which the material breaks when the parts on opposite sides of the restriction are bend relative to each other.

When the kit is formed, in a next step, the kit is ejected as one body from the injection mould, more in particular form the injection mould cavity in which it was formed.

The production phase is followed by the transport phase. The transport phase comprises a packaging step and a transporting step.

In the packaging step, multiple kits are packaged in one retail package. A kit comprises all the components for assembling a letter tray. Furthermore, these components are all connected to each other. Multiple kits can thus be packaged together in one package, for example a container, cardboard box, or shrink wrapped together. There is no risk of components, such as a leaflet or panel, getting lost or mixed up with components of other kits.

Subsequently, the packaged kits are transported from the production location to a vending location, for example a store or warehouse. Typically, these locations are separated from each other, in most case over a distance of 10 km or more.

In the vending phase the kit is sold, separate or for example combined in a package. The panels of each kit are still connected to each other via the breakaway connections. The kits are sold to an end user who will disconnect the panels from each other and will assemble the letter tray.

In contrast with known kits for assembling letter trays, with kits according to the invention the components that make up the final letter tray are produced in one mould and as one product. Furthermore, the components stay connected until the kit is sold to the end user. It is the end user who will disconnect the components and assemble the letter tray.

Since the components are all connected, the kit can be handled as a single object. There is no need for packaging for keeping the components together.

It is the end user who will assemble the letter tray. To facilitate assembly by an unskilled end user, the side panels and the back panel are positioned with their bottom edges along the respective sides and backside of the floor panel. The lay out of the panels in the kit is such that they can be moved into the correct positions with a minimum of translations and rotations.

Thus the kit indicates how the panels should be fit together. The different panels are located and positioned relative to each other such that they minimize the acts necessary for assembling the letter tray.

Furthermore, the kit preferably provides instructions in the form of relief figures formed on components of the kit, preferably on the bottom surface of the floor panel. In a further preferred embodiment, other relief figures are also provided on the components of the letter tray. For example, the front of the floor panel can be provided with a logo.

In the preferred embodiment shown, the front of the floor panel is provided with a rectangular recess which is shaped such that it can hold a label. The recess is open at its top end for inserting the label. The recess is provided with slits along its short ends, and optionally along its long end, for receiving and holding the label. Such a label can for example be used to identify the letter tray with a name or number. Labels may be provided with the kit.

It is observed with a kit according to the invention the components are fixed relative to each other. The kit is thus easy to handle. When the components are connected via for example film hinges, or when separate components are combined in a plastic back, the components are moveable relative to each other and the kit is less easy to handle.

1. Plastic letter tray assembly kit for assembly of a plastic letter tray with an open front side and an open topside, comprising a left side panel, a right side panel, a back panel, and a floor panel, which panels are provided with receiving apertures and/or insert lips, preferably snap fingers, for interconnecting the panels to assemble the letter tray, characterized in that
the panels are formed as one body in an injection mould, wherein the panels are connected to each other via breakaway connections, and wherein the left side panel is positioned with a bottom edge along a left side of the floor panel, the right side panel is positioned with a bottom edge along a right side of the floor panel, and the back panel is positioned with a bottom edge along a backside of the floor panel, and wherein preferably the insert lips and/or receiving apertures of the side panels and the back panel are positioned in the vicinity of the respective receiving apertures and/or insert lips of the floor panel with which they form a snap connection in the assembled letter tray.

2. Kit according to claim 1, wherein the side panels are each connected to the back panel via a breakaway connection for enhancing the stability of the kit.

3. Kit according to claim 1, wherein a back edge of each side panel is connected to a side edge of the back panel via a corner component, which corner component is connected via breakaway connections to the side panel and the back panel, which corner component is formed as one part with the panels, and which corner component preferably comprises one or more plastic paperclips.

4. Kit according to claim 1, wherein the side panels are each provided with a curved back part, and the back panel is provided with partially curved end parts, which curved end parts cooperate with the curved back parts of the side panels to form curved corners in the assembled letter tray.

5. Kit according to claim 1, wherein the floor panel is at its bottom side provided with a figure formed by injection moulding which indicate how to use the kit to assemble the plastic letter tray.

6. Kit according to claim 1, wherein the floor panel is dimensioned such that the assembled letter tray is capable of supporting letters of A4 format.

7. Kit according to claim 1, wherein the floor panel is at its front provided with a recess which enables engaging by hand a letter supported in the letter tray

8. Kit according to claim 1, wherein the floor panel comprises a front area and a back area, which back area extends in a substantially horizontal direction when the assembled letter tray is supported by a horizontal surface, and wherein the front area extends at an angle with the back area.

9. Kit according to claim 1, wherein the floor panel is provided with one or more receiving grooves for receiving a bottom edge of the left and right side panels and the bottom edge of the back panel, which one or more grooves are provided with receiving slots for receiving the insert lips of the side panels and/or the back panel, such that the side panels and the back panel are inserted from above and in a vertical direction into the floor panel when assembling the letter tray.

10. Retail package, for example a box and/or a shrink wrap, comprising multiple, stacked kits according to claim 1, wherein the panels of each kit are connected with each other via breakaway connections.

11. Method for producing and selling a kit for assembly of a plastic letter tray according to claim 1, which method comprises a production phase, a transport phase, and a vending phase, characterized in that,
the production phase comprises the steps:
injection moulding the kit in one mould, the kit comprising the panels for assembly of the plastic letter tray, wherein the panels are connected to each other via breakaway connections;
ejecting the kit as one body from the injection mould;
the transport phase comprises the steps:
packaging multiple kits in one retail package; and
transporting the retail package comprising the kits, preferably over a distance of at least 10 km, from a production location to a vending location;
the vending phase comprises the step:
selling the kits, wherein the panels of each kit are still connected to each other via the breakaway connections, to an end user who will disconnect the panels from each other to assemble the letter tray.

12. Letter tray assembled, preferably via a method according to claim 11, from a kit according to claim 9.
